(19) United States
(12) Patent Application Publication
(10) Pub. No.: US 2005/0208840 A1
(43) Pub. Date: Sep. 22, 2005

(54) Wire to board connector and methods thereof

(76) Inventors: Danna A. Mancini, Worcester, MA (US); Greg Norton, Marlboro, MA (US); Mark A. Wojcicki, Holden, MA (US)

Correspondence Address: Gunnar G.Leinberg, Esq.;Nixon Peabody LLP, Clinton Square, P.O. Box 31051, Rochester, NY, 14603-1051, US

(21) Appl. No.: 11/016,009

(22) Filed: Dec. 17, 2004

Related U.S. Application Data
(60) Provisional application No. 60/530,377, filed on Dec. 17, 2003.

(51) Int. Cl. H01R 4/48

(52) U.S. Cl. 439/729

(57) ABSTRACT

A connector includes a non-conductive housing with a passage which extends through the housing, a biasing device secured in the passage in the housing, and a conductive contact positioned in the passage in the housing. The conductive contact includes a cantilever beam section, a non-linear locking section, and a tail section. The cantilever beam section is connected to the biasing device, the non-linear locking section is seated in the passage in the housing, and the tail section extends from the passage in the housing.

This application claims the benefit of U.S. Provisional Patent Application Ser. No. 60/530,377 filed Dec. 17, 2003 which is hereby incorporated by reference in its entirety.

### FIELD OF THE INVENTION

The present invention relates generally to connectors and, more particularly, to a connector for coupling a wire to a board and methods thereof.

### BACKGROUND

Typically, power is delivered to a circuit board by a power cord which is permanently coupled at one end to the circuit board and which has a plug at the other end that is adapted to fit into a standard wall outlet. This type of connection provides an effective manner for delivering power to the circuit board. However, for some applications it would be desirable to be able to detachably couple power directly to one or more circuit boards or other devices.

### SUMMARY

A connector in accordance with embodiments of the present invention includes a non-conductive housing with a passage which extends through the housing, a biasing device secured in the passage in the housing, and a conductive contact positioned in the passage in the housing. The conductive contact includes a cantilever beam section, a non-linear locking section, and a tail section. The cantilever beam section is connected to the biasing device, the non-linear locking section is seated in the passage in the housing, and the tail section extends from the passage in the housing.

A method for making a connector in accordance with embodiments of the present invention securing a biasing device in a passage in a non-conductive housing and placing a conductive contact in the passage in the housing. The conductive contact includes a cantilever beam section, a non-linear locking section, and a tail section. The cantilever beam section connected to the biasing device, the non-linear locking section seated in the passage in the housing, and the tail section extends from the passage in the housing.

The present invention provides a connector for connecting a power wire or line to a printed circuit board with a quick and easy to use connect/disconnect. The connector is formed in a compact package and provides a finger-proof design for added safety. Additionally, the connector provides the option of coupling the power line to multiple printed circuit boards. Further, the connector provides the option of safely “hot plugging” of a power line to a printed circuit board.

### BRIEF DESCRIPTION OF THE DRAWINGS

FIG. 1 is a perspective view of a connector in accordance with embodiments of the present invention;

FIG. 2 is an end view of the connector shown in FIG. 1

FIG. 3 is a cross-sectional view of the connector shown in FIG. 2 taken along the lines 3-3;

FIG. 4 is an enlarged view of a bowed nose portion of a conductive contact connected to a spring in the connector shown in FIG. 1;

FIG. 5 is a perspective view of a conductive contact before being bent for an application;

FIG. 6 is a side view of the conductive contact shown in FIG. 5;

FIG. 7 is a perspective view of another conductive contact for a connector in accordance with embodiments of the present invention; and

FIG. 8 is a side view of a pair of connectors mounted on a PCB showing two versions of the cut and bent conductors in accordance with embodiments of the present invention.

### DETAILED DESCRIPTION

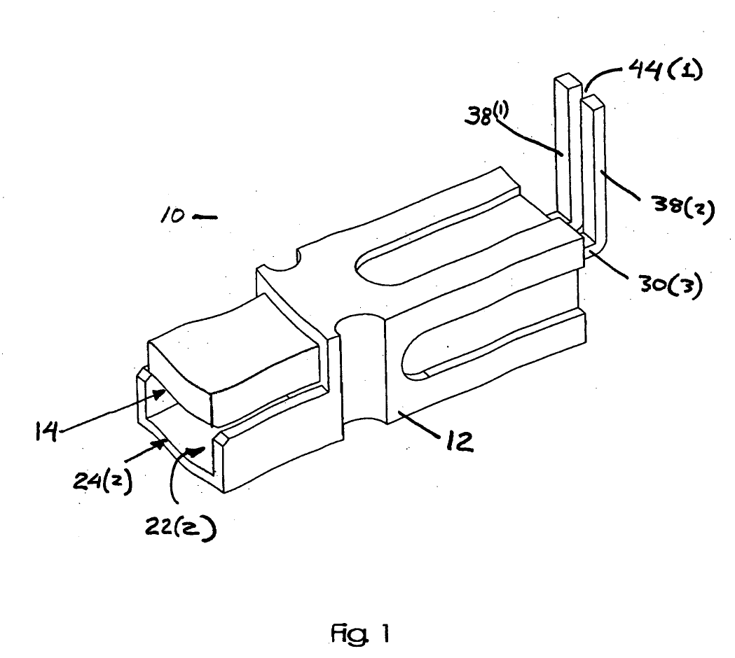

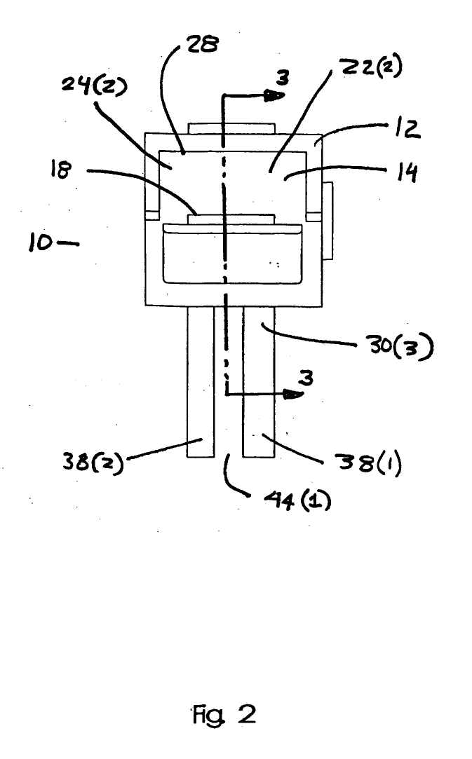

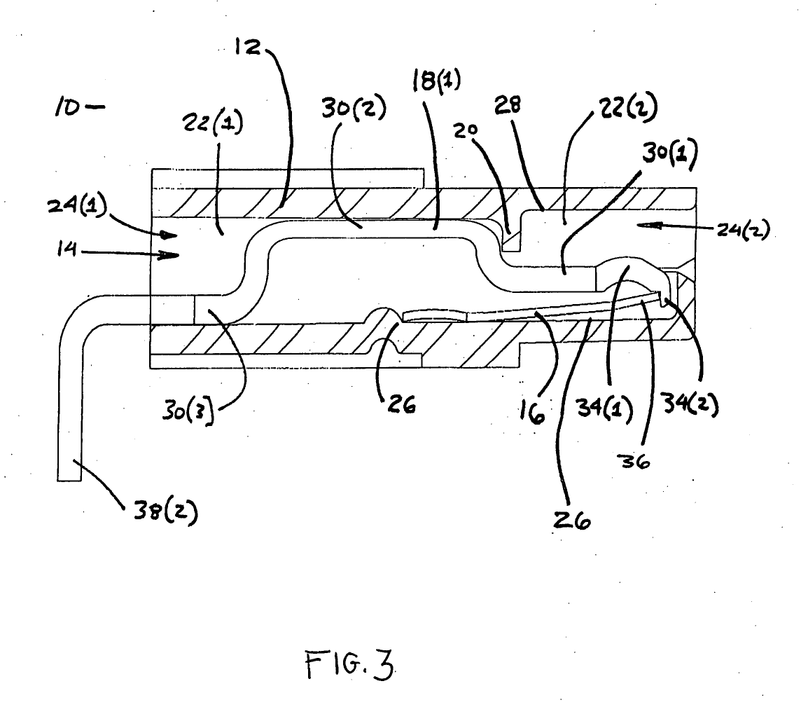

A wire-to-board connector 10 in accordance with embodiments of the present invention is illustrated in FIGS. 1-4. The connector 10 includes a housing 12 with a passage 14, a spring 16, and a conductive contact 18(1), although the connector 10 can include other types and numbers of components connected in other manners. The present invention provides a connector for connecting a power wire or line to a printed circuit board with a quick and easy to use connect/disconnect.

Referring to FIGS. 1-3 the housing 12 is made of an insulating material and has a substantially rectangular shape with the passage 14 that extends through the housing 12, although the housing 12 could be made of other materials, have other shapes and have other numbers of passages. The housing 12 has a projection 20 which is located in and extends partially across the passage 14 to form two chambers 22(1) and 22(2), although other numbers chambers could be formed. One opening 24(1) to chamber 22(1) of the passage 14 defines a space for the portion of the conductive contact 14 that extends out for coupling to a printed circuit board or other device. Another opening 24(2) to chamber 22(2) of the passage 14 defines a space for receiving a similar wire mounted connector from a power source, such as a twenty-five to forty amp lead, although other types of leads could be received. The conductive contact 18(1) in the opening 24(1) to chamber 22(2) forms a genderless contact, although other types of contacts could be used, such as a male or female contact. For added safety, the opening 24(2) is sized smaller than a finger to make the connector 10 finger proof.

The spring 16 is seated in and secured to a surface 26 of the housing 12 in the passage 14 with a securing device, although other types of biasing devices could be used and the spring 16 could be secured to the housing 12 in a variety of other manners. The spring 16 extends from one portion of the chamber 22(1), past the projection 20, and into a portion of the chamber 22(2) in the passage 14, although the spring 16 could be in other locations in the passage 14, such as just in the chamber 22(2). The spring 16 is biased in a direction away from surface 26 and towards surface 28 in the chamber 22(2) in passage 14, although the spring 16 could be secured and biased in other directions and manners.

Referring to FIGS. 1-4, the conductive contact 18(1) includes a cantilever beam section 30(1), a trapezoid locking section 30(2), and a tail section 30(3), although the conductive contact 18(1) could comprise other types and numbers of sections in other configurations. The cantilever beam section 30(1) has a bowed up nose portion 34(1) and a bottom lip 34(2) which is secured to an end 36 of the spring 16 as shown more clearly in FIG. 4, although the cantilever beam section 30(1) and the spring 16 can be connected together in other manners. Securing the bottom lip 34(2) to an end 36 of the spring 16 provides an effective connection between the conductive contact 18(1) and the spring 16. The spring 16 together with the cantilever beam section 30(1) of the conductive contact 16 provides a contact normal force to receive and detachably secure another similar conductive contact inserted in the opening 24(2) to the chamber 22(2) in passage 14. The cantilever beam section 30(1) in the opening 24(2) to the chamber 22(2) provides a genderless conductive contact, although other types of connectors could be used, such as a female or male contact configuration.

The trapezoid locking section 30(2) is integrally formed with the cantilever beam section 30(1) and the tail section 30(3) and is used to secure the conductive contact 18(1) inside the chamber 22(2) in the passage 14 of the housing 12, although other non-linear shaped sections and/or other securing devices could be used to secure the conductive contact 18(1) in the passage 14. In this embodiment, one side of the trapezoid locking section 30(2) is seated against the projection 20 in the passage 14 to prevent movement of the contact conductive contact 18(1) towards the opening 24(2) to the chamber 22(2) in the passage 14.

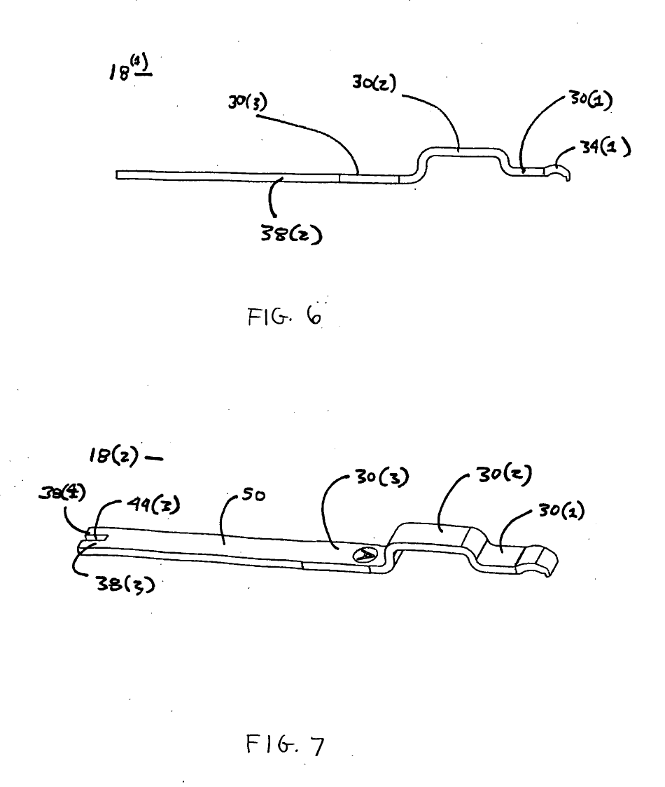

The tail section 30(3) is integrally formed with the trapezoid locking section 30(2) and is used to provide a mechanical and an electrical connection with another component, such as a printed circuit board, although the tail section 30(3) can be coupled to the trapezoid locking section 30(2) in other manners. The tail section 30(3) includes tail portions 38(1)-38(2) which extend out from the passage 14, are spaced apart and are either left straight or bent at a right angle for connection to components, such as circuit boards, although other types of and numbers of tail portions can be used in other configurations, such as those shown by way of example in FIG. 7. The different configurations for the tail sections are useful for different types of applications.

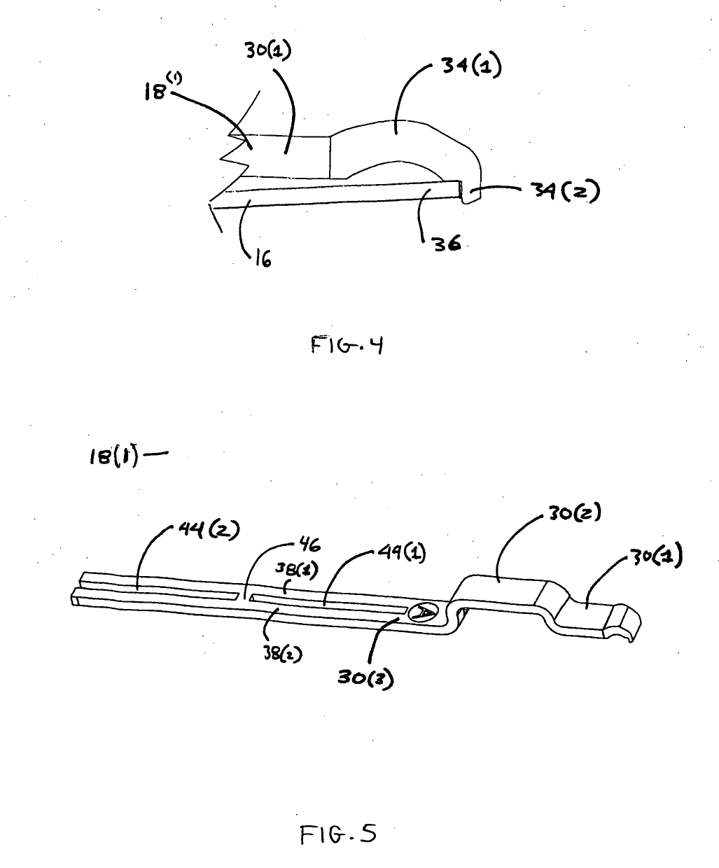

Referring to FIGS. 1-3, 5, and 6, the tail section 30(3) includes a pair of spaced apart tail portions 38(1)-38(2), although the tail sections 30(3) could have other types and numbers of tail portions. Gaps 44(1) and 44(2) separate the tail portions 38(1)-38(2) on either side of a bridge portion 46. The bridge portion 46 extends between the tail portions 38(1)-38(2) to provide structural stability, although the tail portions 38(1)-38(2) could have other configurations. The tail section 30(3) of the conductive contact 18(1) is secured to a printed circuit board (PCB) by soldering or through the use of a conductive bolt, although other manners for coupling the tail portions 38(1)-38(2) to devices can be used. The conductive contact 18(1), in particular the tail section 30(3) prior to being bent for a particular application is illustrated in FIGS. 5-6.

Referring to FIG. 7, another conductive contact 18(2) for the connector 10 in accordance with other embodiments of the present invention is illustrated. Elements in FIG. 7 which are like elements shown and described in FIGS. 1-6 will have like reference numerals and will not be described in detail here again. Additionally, for these embodiments the remaining elements of the connector 10 are the same as those described above with reference to FIGS. 1-4 and will not be described again here.

The conductive contact 18(2) includes a cantilever beam section 30(1), a trapezoid locking section 30(2), and a tail section 30(3), although the conductive contact 18(2) could comprise other types and numbers of sections in other configurations. The tail section 30(3) is integrally formed with the trapezoid locking section 30(2) and is used to provide a mechanical and an electrical connection with another component, such as a printed circuit board, although the tail section 30(3) can be coupled to the trapezoid locking section 30(2) in other manners. The tail section 30(3) includes a base conductor 50 which extends out from the passage 14 and for connection to components, such as a circuit board, although other types of and numbers of tail portions can be used.

The base conductor 50 includes a pair of spaced apart tail portions 38(3)-38(4) formed in an end of the base conductor 50, although base conductor 50 could have other types and numbers of base and/or tail portions. A gap 44(3) separates the tail portions 38(3)-38(4), although the base conductor 50 and tail portions 38(3)-38(4) could have other configurations. The tail section 30(3) of the conductive contact 18(1) is secured to a printed circuit board (PCB) by soldering or through the use of a conductive bolt which passes through the gap 44(3) and couples the tail portions 38(3)-38(4) to a conductor on a circuit board, although other manners for coupling the tail section 30(3) to devices can be used.

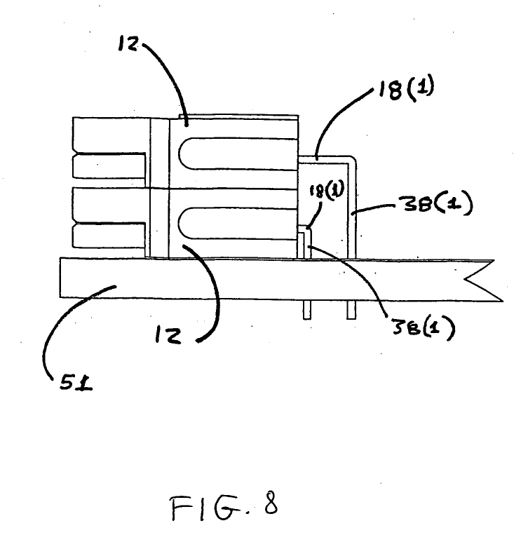

Referring to FIG. 8, two housings 12 are stacked and mounted to a PCB 51, demonstrating the implementation of two cut and bent versions of conductor 18(1).

A method of making and using a connector 10 in accordance with embodiments of the present invention will now be described with reference to FIGS. 1-4. A spring 16 is positioned in and secured to a surface 26 of the housing 12 in the passage 14. More specifically, the spring 16 is positioned to extend from one portion of the chamber 22(1), past the projection 20, and into a portion of the chamber 22(2) in the passage 14, although other manners and configurations for securing a biasing device can be used. The spring 16 is biased in a direction away from surface 26 and towards surface 28 in the chamber 22(2) in the passage 14, although the spring 16 can be biased in other directions.

Next, a conductive contact 18(1) is positioned in the passage 14 of the housing 12. More specifically, a cantilever beam section 30(1) is positioned in a chamber 22(2), a trapezoid locking section 30(2) is positioned in chamber 22(1) and has a surface which abuts against the projection 20, and a tail section 30(3) is positioned to extend out from an opening 24(1) to the chamber 22(1), although other manners and configurations for positioning the conductive contact 18(1) in the passage 14 can be used. A bottom lip 34(2) of a bowed up nose portion 34(1) for the cantilever beam section 30(1) is secured to an end 36 of the spring 16, although the spring 16 and cantilever beam section 30(1) can be connected in other manners. The spring 16 biases the cantilever beam section 30(1) towards the opposing surface 28 in the chamber 22(2) in passage 14, although the cantilever beam section 30(1) can be biased in other directions.

Next, a conductive securing device, such as solder, is passed through the gap 44(1) or 44(2) and couples the tail portions 38(1)-38(2) to a conductor on one circuit board, although other manners for coupling the tail portions 38(1)-38(2) to devices can be used.

A power line with a mating connector is inserted in the opening 24(2) to the chamber 22(2) and engages with the cantilever beam section 30(1). As the mating connector is inserted the spring 16 biases the cantilever beam section 30(1) against the mating connector to form a snug electrical connection to couple power through the connector 10 to the device or devices coupled to the tail section 30(3). Although the connection is illustrated as being genderless, other types of mating configurations could be used. Power can also be easily and safely disconnected from the connector 10 by disconnecting the mating connector from the cantilever beam section 30(1) in the chamber 22(2).

The method for making a connector 10 with one of the other conductive connectors 18(2) is the same as described above with respect to the conductive connector 18(1) and thus will not be described again here, except that the configuration of the connection between each of the conductive portions 38(3)-38(4) to a circuit board or other device is slightly different from the conductive connector 18(1). The method and configuration of connecting each of the conductive portions 38(3)-38(4) to a circuit board or other device has been described earlier and thus will not be described again here.

Accordingly, the present invention provides a connector for connecting a power wire or line to a printed circuit board with a quick and easy to use connect/disconnect. The connector is formed in a compact package and provides a finger-proof design for added safety. Additionally, the connector provides the option of coupling the power line to multiple printed circuit boards. Further, the connector provides the option of safely “hot plugging” of a power line to a printed circuit board.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A connector comprising:
a non-conductive housing with a passage which extends through the housing;
a biasing device secured in the passage in the housing; and
a conductive contact positioned in the passage in the housing, the conductive contact comprising a cantilever beam section, a non-linear locking section, and a tail section, the cantilever beam section connected to the biasing device, the non-linear locking section seated in the passage in the housing, and the tail section extending from the passage in the housing.

2. The connector as set forth in claim 1 wherein the cantilever beam section further comprises a bowed nose portion.

3. The connector as set forth in claim 2 wherein the bowed nose portion has a lip which is connected to an end of the biasing device.

4. The connector as set forth in claim 1 wherein the passage in the housing comprises at least two separated chambers, wherein the cantilever beam section is substantially positioned in one of the at least two separated chambers and the non-linear locking section is substantially positioned in another one of the at least two separated chambers.

5. The connector as set forth in claim 4 wherein the non-linear locking section has a partially, trapezoidal shape.

6. The connector as set forth in claim 1 wherein the tail section further comprises two or more tail portions.

7. The connector as set forth in claim 6 wherein each of the two or more tail portions comprise two or more tail conductors, wherein the two or more tail conductors are substantially parallel to and are separated by a gap from each other.

8. The connector as set forth in claim 6 wherein the tail portions have at least one bend.

9. The connector as set forth in claim 6 wherein the tail portions are left straight.

10. A method for making a connector, the method comprising:
securing a biasing device in a passage in a non-conductive housing; and
placing a conductive contact in the passage in the housing, the conductive contact comprising a cantilever beam section, a non-linear locking section, and a tail section, the cantilever beam section connected to the biasing device, the non-linear locking section seated in the passage in the housing, and the tail section extending from the passage in the housing.

11. The method as set forth in claim 10 wherein the cantilever beam section further comprises a bowed nose portion.

12. The method as set forth in claim 11 further comprising connecting the lip of the bowed nose portion to an end of the biasing device.

13. The method as set forth in claim 10 wherein the passage in the housing comprises at least two separated chambers and further comprising substantially positioning the cantilever beam section in one of the at least two separated chambers and substantially positioning the non-linear locking section in another one of the at least two separated chambers.

14. The method as set forth in claim 13 wherein the non-linear locking section has a partially, trapezoidal shape.

15. The method as set forth in claim 10 wherein the tail section further comprises two or more tail portions.

16. The method as set forth in claim 15 wherein the tail portions comprise two or more tail conductors, wherein the two or more tail conductors are substantially parallel to and are separated by a gap from each other.

17. The connector as set forth in claim 15 wherein the tail portions has at least one bend.
